(19) United States
(12) Patent Application Publication
(10) Pub. No.: US 2007/0019025 A1
(43) Pub. Date: Jan. 25, 2007

(54) Image forming apparatus having a printing medium preheating device

(75) Inventor: Jong-sung Jung, Suwon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/453,857

(22) Filed: Jun. 16, 2006

(30) Foreign Application Priority Data
Jun. 16, 2005 (KR) 2005-0051719

(51) Int. Cl. B41J 29/38

(52) U.S. Cl. 347/17

(57) ABSTRACT

Provided is an image forming apparatus capable of improving printing speed and image quality. The image forming apparatus includes a print head having a plurality of heaters for heating a printing medium and a driving chip unit for selectively driving the heaters according to printing data. Also included is a feeding unit that transfers the printing medium to the print head. The driving chip unit has a first preheating part for preheating the printing medium before the printing medium is directly heated by the heaters.

### CROSS-REFERENCE TO RELATED APPLICATION

This application claims the benefit under 35 U.S.C. §119(a) of Korean Patent Application No. 2005-51719, filed Jun. 16, 2005, the entire disclosure of which is hereby incorporated by reference.

### BACKGROUND OF THE INVENTION

1. Field of the invention

The present invention relates to a thermal image forming apparatus. More particularly, the present invention relates to a thermal image forming apparatus that produces an image by heating a printing medium in accordance to printing data.

2. Description of the Related Art

Generally, a thermal image forming apparatus comprises a thermal print head (TPH) that includes a plurality of heaters, a feeding unit and a control unit. The TPH is used for forming an image on a printing medium such as thermal recording paper. The feeding unit is used for transferring the printing medium to the TPH. The control unit is used for controlling the feeding unit and the TPH.

The control unit transmits printing data received from a host device, such as a computer, to the TPH. Heaters selected by the printing data apply heat to selected dot on the printing medium. Therefore, the each of the selected dots on the printing medium develops having respectively different colors according to resulting temperature of the dot caused by the heat application, thereby forming a desired image.

The color development at the dot is generally performed at a temperature of about 100˜220° C., whereas the normal temperature of the printing medium is usually about 10˜40° C. Accordingly, energy corresponding to approximately 60˜210° C. is required to be transmitted by the heaters in order to form an image on the printing medium. The greater the amount of thermal energy that transmitted to the printing medium, the longer amount of time it takes for a heater of a given capacity to apply the heat to the printing medium. Therefore, printing speed is deteriorated as the amount of thermal energy required increases.

Recently, research is being conducted to improve the printing speed of the thermal image forming apparatus. In particular, a method for reducing the heat transmission time of the heater to the printing medium is being studied to enhance the printing speed.

Meanwhile, thermal image forming apparatuses suffer from a problem that there can be up to a 30° C. temperature difference between different portions of a printing medium or between different printing mediums. The temperature difference is a problem because the heater of a conventional thermal image forming apparatuses uniformly applies thermal energy to each dot so as to develop uniform color. However, the temperature difference may cause the development of different colors, thereby deteriorating image quality.

Accordingly, there is a need for an improved thermal image forming apparatuses that enhancing printing speed and can account for different temperatures in the printing medium so as to develop uniform color.

### SUMMARY OF THE INVENTION

Exemplary embodiments of the present invention address at least the above problems and/or disadvantages and provide at least the advantages described below. Accordingly, an aspect of the present invention is to provide an image forming apparatus capable of enhancing printing speed.

Another aspect of an exemplary embodiment of the present invention is to provide an image forming apparatus capable of improving image quality.

In order to achieve the above-described aspects of an exemplary embodiment of the present invention, there is provided an image forming apparatus comprising a print head comprising a plurality of heaters for heating a printing medium and comprising a driving chip unit for selectively driving the heaters according to printing data; and a feeding unit for transferring the printing medium to the print head, wherein the driving chip unit having a first preheating part that preheats the printing medium before the printing medium is directly heated by the heaters.

The driving chip unit comprises a plurality of driving chips electrically coupled to the plurality of heaters, and a printed circuit board (PCB) supporting the driving chips. The first preheating part comprises a heat-conductive medium for transmitting heat generated from the driving chip to the printing medium. The heat-conductive medium is mounted on the PCB to cover the driving chips and is made of aluminum. The heat-conductive medium is protrudes further than the heater with respect to the PCB. The heat-conductive medium is contacts the printing medium by area-contact. The print head further comprises a radiator member that contacts with the PCB on one side thereof.

According to an exemplary embodiment of the present invention, the image forming apparatus comprises a main body rotatably supporting the print head; a driving motor mechanically coupled to the print head; and a control unit for controlling the driving motor, after an image is formed on one side of the printing medium, so that the print head is rotated about a platen roller in order to form another image on the other side of the printing medium. The print head further comprises a radiator member contacting with the PCB on one side thereof with respect to a printing medium feeding direction. The radiator member contacts with a substrate supporting the heaters and comprises a second preheating part on the other side thereof with respect to the printing medium feeding direction. The second preheating part protrudes more than the heaters.

A surface of the second preheating part, which contacts with the printing medium, is curved to guide the printing medium.

Other objects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWING FIGURES

The above and other objects, features, and advantages of certain embodiments of the present invention will be more apparent from the following description taken in conjunction with the accompanying drawings, in which:

FIG. 1 is a sectional view of an image forming apparatus according to an exemplary embodiment of the present invention;

FIG. 2 is a sectional view showing the main elements of FIG. 1;

FIG. 3 is a perspective view schematically showing a print head of FIG. 1;

FIG. 4 is a sectional view schematically showing a printing medium used in the image forming apparatus of FIG. 1; and

FIG. 5 is a block diagram illustrating a control structure of the image forming apparatus of FIG. 1.

Throughout the drawings, the same drawing reference numerals will be understood to refer to the same elements, features, and structures.

### DETAILED DESCRIPTION OF EXEMPLARY EMBODIMENTS

The matters defined in the description such as a detailed construction and elements are provided to assist in a comprehensive understanding of the embodiments of the invention and are merely exemplary. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

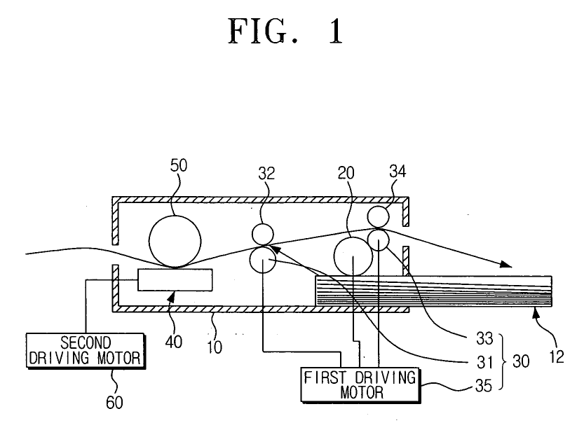

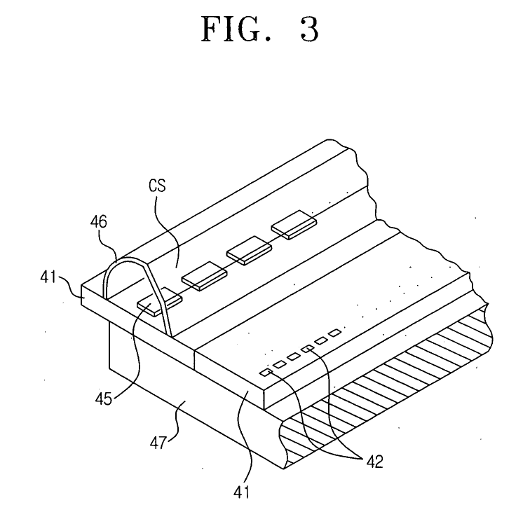

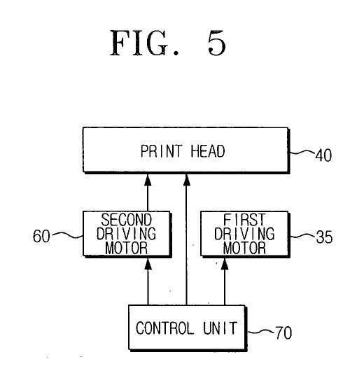

Referring to FIGS. 1 to 5, an image forming apparatus according to an exemplary embodiment of the present invention comprises a main body 10 including a paper supply cassette 12, a pickup roller 20, a feeding unit 30, a print head 40, a platen roller 50 and a control unit 70. Paper supply cassette 12 is used to load printing mediums. Pickup roller 20 picks up the printing medium loaded in the paper supply cassette 12. Feeding unit 30 transfers the printing medium picked up by the pickup roller 20. Print head 40 forms an image by heating the printing medium being transferred by the feeding unit 30 in accordance with printing data. Platen roller 50 supports the printing medium while the print head 40 is forming the image. Control unit 70 controls the operation of the pickup roller 20, the feeding unit 30 and the print head 40.

The feeding unit 30 comprises a feed roller 31, a discharge roller 33, and a first driving motor 35. The feed roller 31 rotates while in contact with a first idle roller 32 to transfer the printing medium picked up by the pickup roller 20 toward the print head 40 or from the print head 40 toward the discharge roller 33. The discharge roller 33 rotates while in contact with a second idle roller 34 and ejects the printing medium to a discharged-paper tray (not shown) after the printing process is complete. The first driving motor 35 is mechanically coupled to the feed roller 31, the discharge roller 33 and the pickup roller 20, and supplies a rotative force to the above rollers 31, 33 and 20. In addition, the first driving motor 35 is electrically coupled to the control unit 70 so that control unit 70 can control the driving and rotating direction of the first driving motor 35.

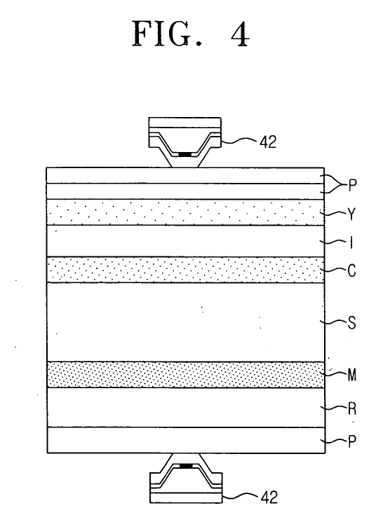

The print head 40 is mounted to the main body 10 so as to rotate about the platen roller 50 in order to form the image on a double-side thermal printing medium, as shown in FIG. 4. Further, the print head 40 is mechanically coupled to the second driving motor 60 which is electrically coupled to the control unit 70. Therefore, the control unit 70, by controlling the second driving motor 60, rotates the print head 40 about the platen roller 50.

The print head 40 comprises a ceramic substrate 41, a driving chip unit 43 and a radiator member 47. Ceramic substrate 41 comprises a plurality of heaters 42 spaced apart at an interval and are arranged along a line that is perpendicular to the path of the printing medium. Driving chip unit 43 controls the respective heaters 42 by classifying the heaters 42 based on the printing data transmitted from the control unit 70. Radiator member 47 releases heat generated by the driving chip unit 43.

The interval between the plurality of heaters 42 is determined according to a maximum width of the printing medium with which the image forming apparatus can achieve image formation.

The driving chip unit 43 comprises a printed circuit board (PCB) 44 provided with a circuit of a predetermined pattern, a plurality of driving chips 45 mounted on the PCB 44, and an heat-conductive medium 46. Heat-conductive medium 46 is a first preheating part supported by the PCB 44 to cover the plurality of driving chips 45. Here, a protection layer (not shown) may further be provided to shield the driving chips 45.

The PCB 44 comprises the circuit of the predetermined pattern for transmitting to the respective driving chips 45 the signal and power which are transmitted from the control unit 70. The driving chips 45 are mounted on one side of the PCB 44 and the radiator member 47 is attached on the other side of the PCB 44.

The driving chips 45 control the heaters 42 as classified into a plurality of groups. In other words, when the printing data is transmitted to the respective driving chips 45 from the control unit 70, the driving chips 45 control driving, driving time and driving temperature of each group of the heaters 42. The driving chips 45 generates heat using electrical resistance so that the temperature of the driving chips 45 is maintained at approximately 65° C. while the image is formed.

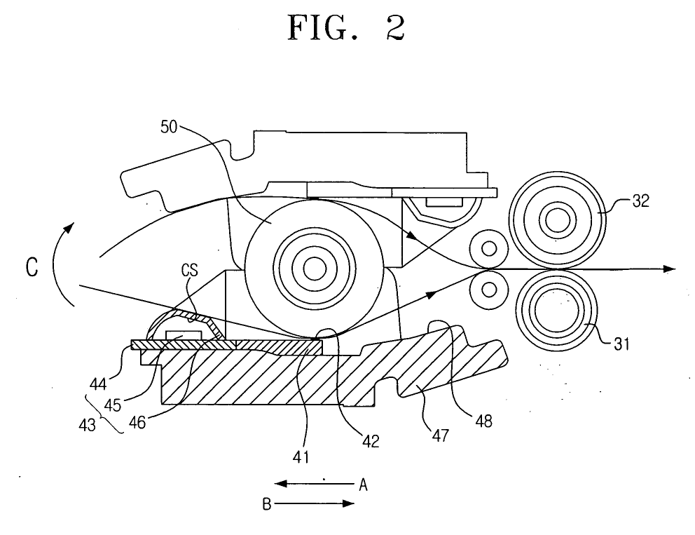

The heat-conductive medium 46 transmits the heat generated from the driving chips 45 to the printing medium. Therefore, the heat-conductive medium 46 is preferably formed of materials having high thermal conductivity, such as aluminum. However, other material may be used to conduct the heat. Before the printing medium is transferred to the heater 42, the heat-conductive medium 46 makes contact with the printing medium being transferred so as to transmit the heat transmitted from the driving chip 45 to the printing medium. The heat-conductive medium 46 makes contact with the printing medium in order to enhance the efficiency of thermal conduction to the printing medium. For this purpose, the heat-conductive medium 46 has a dome shaped protrusion from the PCB 44 and a planer contacting surface CS for making contact with the printing medium. In addition, since the printing medium has a predetermined stiffness, as the printing medium is curved by a given extent and a recovery force is generated. The heat-conductive medium 46 is protrudes more than the heater 42 so that the contact pressure between the printing medium and the heat-conductive medium 46 is enhanced. Therefore, the printing medium entering the heater 42 has a curved form as shown in FIG. 2.

The radiator member 47 is attached to one side of the ceramic substrate 41 and the PCB 44. By virtue of the attachment, radiator member 47 receives the heat generated by the heater 42 and the PCB 44. The radiator member 47 includes a second preheating part 48 at the opposite side of the driving chip unit 43 inline with the path of the printing medium with respect to the heater 42. The second preheating part 48 preheats the printing medium, when being positioned as shown by a line in FIG. 2 by rotation of the print head 40. The second preheating part 48 protrudes more than the heater 42 in order to enhance the contact pressure with the printing medium using the recovery force caused by the stiffness of the printing medium. As shown by the line in FIG. 2, the printing medium entering the heater 42 is curved by a given amount. The contact surface of the second preheating part 48 that contacts with the printing medium is preferably curved to correspond to the curved surface of the printing medium. Since the second preheating part 48 receives the heat generated from the driving chip 45 as well as from heater 42 in order to transmit the heat to the printing medium, the preheating temperature for the printing medium can be increased.

Although a single print head 40 is adopted to heat both sides of the printing medium in this exemplary embodiment, any number of the print heads 40 may alternatively be used. For example, two print heads may be used for the same purpose.

The platen roller 50 is mounted to face the heater 42 and is supported by the main body 10 for idle rotation. Being rotated by the printing medium entering the heater 42, the platen roller 50 supports the printing medium.

The control unit 70 may be implemented by a main controller of the image forming apparatus or a controller of a host device such as a computer so as to control the image forming processes. Functions of the control unit 70 will be described in greater detail hereinafter, regarding the operation of the image forming apparatus according to an exemplary embodiment of the present invention.

Reference symbols P, I, S, and R of the printing medium in FIG. 4 respectively denote a protection layer, a separation layer, a support layer, and a reflection layer, which are made of transparent materials. Since this structure of the printing medium is generally known, a detailed description thereof will be omitted.

Referring to FIGS. 1 to 5, the operation of an exemplary embodiment of the present invention will now be described.

When a printing command is issued from the host device such as a computer, the control unit 70 controls the first driving motor 35 to pick up and transfer the printing medium in a direction indicated by arrowed direction A of FIG. 2. After transferring the printing medium in the direction A, the control unit 70 rotates the first driving motor 35 in an opposite direction to transfer the printing medium back in an arrowed direction B. During this process, the printing medium is preheated through contact with the heat-conductive medium 46 and receives the heat generated from the driving chip 45 before entering the heater 42.

As described above, the printing medium is preheated by the heat-conductive medium 46 before the image is formed by the heater 42, so that the difference between the temperature of the printing medium and the temperature required for forming the image on the printing medium is decreased. Accordingly, as the thermal energy that the heater 42 has to transmit to the printing medium is decreased, the time for heating the printing medium can be decreased. As a result, printing speed is improved. In addition, power consumption can be reduced by utilizing the waste heat generated from the driving chip 45. Also, the color development can be better controlled since temperature difference between portions in one printing medium or between different printing mediums is thus reduced, thereby improving the image quality. Furthermore, by reducing the thermal energy transmitted from the heater 42 to the printing medium, thermal stress of the heater 42 can be reduced, thereby elongating the lifespan of the heater 42.

On the preheated printing medium, the image is formed by the heater 42 according to the printing data. The control unit 70 transmits the printing data to the plurality of driving chips 45. The driving chips 45 receiving the printing data control the driving, the driving time and the driving temperature of the respective heaters 42. In this exemplary embodiment, the dual-side thermal printing medium, as shown in FIG. 4, is illustrated and explained and the image formation is performed by heating a magenta layer M.

After the magenta image is formed, the control unit 70 operates the second driving motor 60 to rotate the print head 40 about the platen roller 50 in an arrowed direction C to the position illustrated by the line. After the print head 40 is rotated, the control unit 70 operates the first driving motor 35 to transfer the printing medium on which the magenta image is formed to the direction A. Here, the printing medium is advanced over an upper part of the platen roller 50.

When the transferring of the printing medium in the direction A is completed, the control unit 70 operates the first driving motor 35 in the opposite direction to thereby transfer the printing medium in the direction B. At this time, the printing medium is brought into contact with the second preheating part 48 provided at the radiator member 47 and is preheated before entering the heater 42. Thus, through the radiator member 47, the waste heat generated from the heater 42 and the driving chip 45 is utilized in preheating the printing medium, thereby reducing power consumption. In forming the image on the preheated printing medium using the heater 42, a yellow layer Y and a cyan layer C are developed, as shown in FIG. 4. The development of each layer is determined by the temperature. For example, the yellow layer Y is developed at approximately 210° C. while the cyan layer C at approximately 110° C. Therefore, in order to develop only the yellow layer Y, for example, the thermal energy transmitted by the heater 42 to the printing medium is increased and the heating time is shortened. In order to develop only the cyan layer C, the thermal energy is decreased and the heating time is elongated. Other colors can be formed by properly mixing the magenta M, yellow Y, and cyan C.

After the image formation is completed through the above processes, the printing medium is discharged by the discharge roller 33 to the discharged-paper tray (not shown).

As described above, according to an exemplary embodiment of the present invention, the printing speed can be improved by preheating the printing medium using the waste heat generated from the driving chip or the heater before forming the image on the printing medium. Also, power consumption is reduced by saving the thermal energy transmitted by the heater to the printing medium.

Moreover, since the temperature difference between portions in one printing medium or between different printing mediums is decreased by preheating the printing medium, image quality can be improved.

By transmitting the waste heat generated from the driving chip and the heater to the printing medium, instead of radiating the waste heat to the outside, a radiating structure can be simplified and downsized, thereby reducing the size of the entire image forming apparatus.

As the thermal energy for the heater to transmit to the printing medium is decreased, energy transmitted to the heater is also decreased. This reduces thermal stress applied to the heater, thereby improving the lifespan of the heater.

While the invention has been shown and described with reference to certain embodiments thereof, it will be understood by those skilled in the art that various changes in form and details may be made therein without departing from the spirit and scope of the invention as defined by the appended claims.

What is claimed is:

1. An image forming apparatus comprising:
a print head comprising a plurality of heaters for heating a printing medium, and comprising a driving chip unit for selectively driving the heaters according to printing data; and
a feeding unit for transferring the printing medium to the print head,
wherein the driving chip unit has a first preheating part that preheats the printing medium before the printing medium is directly heated by the heaters.

2. The image forming apparatus of claim 1, wherein
the driving chip unit comprises a plurality of driving chips electrically coupled to the plurality of heaters, and
the first preheating part comprises a heat-conductive medium for transmitting heat generated from the driving chip to the printing medium.

3. The image forming apparatus of claim 2, wherein the driving chip unit comprises a printed circuit board (PCB) supporting the driving chips, and the heat-conductive medium being mounted on the PCB to cover the driving chips.

4. The image forming apparatus of claim 3, wherein the heat-conductive medium is made of aluminum.

5. The image forming apparatus of claim 4, wherein the heat-conductive medium protrudes further than the heater with respect to the PCB.

6. The image forming apparatus of claim 5, wherein the heat-conductive medium contacts the printing medium by area-contact.

7. The image forming apparatus of claim 6, wherein the print head further comprises a radiator member that contacts with the PCB on one side thereof.

8. The image forming apparatus of claim 7, further comprising:
a main body rotatably supporting the print head;
a driving motor mechanically coupled to the print head; and
a control unit for controlling the driving motor, after an image is formed on one side of the printing medium, so that the print head is rotated about a platen roller in order to form another image on the other side of the printing medium.

9. The image forming apparatus of claim 8, wherein the radiator member contacts with a substrate supporting the heaters and comprises a second preheating part on the other side thereof.

10. The image forming apparatus of claim 9, wherein the second preheating part protrudes further than the heaters with respect to the PCB.

11. The image forming apparatus of claim 10, wherein a surface of the second preheating part, which contacts with the printing medium, is curved to guide the printing medium.

12. The image forming apparatus of claim 11, wherein the radiator member is made of aluminum.

13. An image forming apparatus comprising:
a main body;
a print head rotatably mounted on the main body and comprising a plurality of heaters and a driving chip unit for selectively driving the heaters on one side thereof with respect to a printing medium feeding direction;
a feeding unit for transferring the printing medium to the print head; and
a control unit for controlling the driving motor, after an image is formed on one side of the printing medium, so that the print head is rotated about a platen roller in order to form another image on the other side of the printing medium,
the driving chip unit having a first preheating part for preheating one side of the printing medium.

14. The image forming apparatus of claim 13, further comprising a radiator member attached to one side of a substrate supporting the plurality of heaters, the radiator member comprising a second preheating part on the other side thereof with respect to the printing medium feeding direction for preheating the other side of the printing medium.

15. The image forming apparatus of claim 14, wherein
the driving chip unit comprises a plurality of driving chips electrically coupled to the heaters and a PCB supporting the driving chips, and
the first preheating part comprises a heat-conductive medium that transmits heat generated from the driving chip to the printing medium.

16. The image forming apparatus of claim 15, wherein the radiator member contacts with the PCB on one side thereof.

17. The image forming apparatus of claim 16, wherein the heat-conductive medium and the radiator member are made of aluminum and are in area-contact with the printing medium.

18. An image forming apparatus comprising:
a print head comprising a plurality of heaters for heating a printing medium;
a driving chip unit for selectively driving the heaters according to printing data;
a feeding unit for transferring the printing medium to the print head; and
a preheating part for transmitting heat generated from the driving chip unit to the printing medium before the printing medium is directly heated by the heaters.

19. An image forming apparatus comprising:
a print head comprising a plurality of heaters for heating a printing medium;
a driving chip unit for selectively driving the heaters according to printing data;
a feeding unit for transferring the printing medium to the print head;
a radiator member for radiating heat generated from the heaters and the driving chip unit; and
a preheating part for transmitting the heat generated from the driving chip unit and the heaters to the printing medium before the printing medium is directly heated by the heaters.

20. The image forming apparatus of claim 19, wherein preheating part comprises:
a first preheating part for preheating one side of the printing medium using the heat generated from the driving chip unit; and
a second preheating part formed on one side of the radiator member for preheating the other side of the printing medium using the heat generated from the driving chip unit and the heaters.
